(19) United States
(12) Patent Application Publication
(10) Pub. No.: US 2011/0062631 A1
(43) Pub. Date: Mar. 17, 2011

(54) Curing Pin Material Optimization

(75) Inventor: Christopher S. Madden, Simpsonville, SC (US)

(73) Assignees: MICHELIN RECHERCHE ET TECHNIQUE S.A., Granges-Paccot (CH); SOCIETE DE TECHNOLOGIE MICHELIN, Clermont-Ferrand (FR)

(21) Appl. No.: 12/993,383

(22) PCT Filed: May 22, 2008
(86) PCT No.: PCT/US08/64527

§ 371 Date: Nov. 18, 2010

(51) Int. Cl. B29C 35/02; B29D 30/00

(52) U.S. Cl. 264/326; 425/28.1

(57) ABSTRACT

A method to cure a non-uniform rubber article uses one or more high thermal diffusivity pins in a mold to direct heat to the cure-limiting parts of the article to reduce the total cure time in the mold and increase the uniformity of the cure of the article. Reductions in cure time of up to 20% or more are achieved without substantially changing the function or degrading the performance of the article. The method is particularly useful for curing tires and treads for tires. Finite element analysis or thermocouple probes can used to determine the cure-limiting part(s) for the tire or tread. Using this knowledge, one or more of the high thermal diffusivity pins are located in the mold at positions to transfer heat into the cure-limiting part(s).

### BACKGROUND OF THE INVENTION

1. Field of the Invention

The present invention is in the field of curing rubber articles, and more particularly in the field of curing non-uniform rubber articles such as tires and treads for tires.

2. Description of the Related Art

Rubber articles, such as tires, for years have been vulcanized or cured in a press wherein heat is applied externally through the tire mold and internally by a curing bladder or other apparatus for a certain length of time to effect vulcanization of the article. Presses for tires are well known in the art, and generally employ separable mold halves or parts (including segmented mold parts) with shaping and curing mechanisms, and utilize bladders into which shaping, heating and cooling fluids or media are introduced for curing the tires. The aforesaid curing presses typically are controlled by a mechanical timer or a programmable logic controller (PLC) which cycles the presses through various steps during which the tire is shaped, heated and in some processes cooled prior to unloading from the press. During the curing process the tire is subjected to high pressure and high temperature for a preset period of time which is set to provide sufficient cure of the most non-uniform part(s) of the tire. The cure process usually continues to completion outside the press.

Rubber chemists are faced with the problem of predicting the time period within which each part of the rubber article will be satisfactorily cured and, once such a time period is established, the article is heated for that period. This is a relatively straight-forward process for curing a rubber article that is relatively thin and has uniform geometry and/or similar composition throughout. It is a much more difficult process when this is not the situation such as curing a complex article like a tire. This is particularly true when curing large tires such as truck tires, off-the-road tires, farm tires, aircraft tires and earthmover tires. The state and extent of cure in these types of tires is affected not only by the variance in geometry from part to part in the tire but also by composition changes and laminate structure as well. While the time control method has been used to cure millions of tires, because of the varying composition and geometry in the tire, some parts of the tire tend to be more cured than other parts. By setting the time period to cure the most difficult part(s) to cure, over-cure of some part(s) can occur; and production time on the vulcanizing machinery is wasted and production efficiency is reduced.

Various designs for curing presses and various curing methods have been proposed to provide a more uniform cure to thick rubber articles. Some methods use differing materials for mold construction, insulating materials, differing compositions for parts of the tire, multiple curing zones so heat can be applied for a longer time, or methods for directing more heat to the thickest or most complex part of the rubber article. However, none of the above methods and apparatus has proven entirely satisfactory, and time control remains the typical method of curing non-uniform thick rubber articles. Thus, the tire industry is faced with an issue of producing a uniformly cured tire in a faster time period.

### SUMMARY OF THE INVENTION

The invention is directed to an improved method of curing a rubber article, particularly a non-uniform rubber article such as a tire or a tread for a tire. The method uses at least one high thermal diffusivity pin which is placed in a mold at a location to transfer heat into the article at a cure-limiting part of the article. The method not only results in a much shorter cure time for the article but also results in a more uniform state of cure for the rubber article. The use of the pins results in small apertures, basically seen as pin holes in the article where the pins protruded into the article. Since these apertures are small, they do not change the relative function and performance of the article.

Conventional curing molds and presses can be employed. The conventional mold is adapted or a new mold is made by adding at least one high thermal diffusivity pin located in at least one position in the mold located to direct heat into a cure-limiting part of the rubber article. The mold and the curing apparatus as a whole are only slightly altered, and the compositions of the rubber article are not changed or adjusted. A reduction in total cure time in the mold of up to 20% or more is achieved, which increases productivity without adding expensive molds and curing presses.

### BRIEF DESCRIPTION OF THE DRAWINGS

FIG. 1 shows an aluminum mold (14, 16) used to test the materials of construction of the pins. The pin locations (12a, 12b, 12c) are on the top of the mold (14).

FIG. 2 shows the location of the pins (12a, 12b, 12c) in the rubber block (15), and the location of the thermocouples (5-11) in the rubber block (15) to record temperatures at various positions in the block.

FIG. 3 shows the time to reach a temperature in the rubber block at a given distance from the pin when using pins made of different materials.

FIG. 4 shows the reduction in time to reach a cure state of alpha=0.9 in a rubber block when using pins made of different materials at different distances from the pin.

FIG. 5 is a partial profile of a typical truck tire shoulder area showing the non-uniformity of the tire.

FIG. 6 shows the thermal profile in the shoulder of the truck tire profile of FIG. 5 when the tire is cured using conventional time control methods.

FIG. 7A shows a mold section for the shoulder region of a tire that has been modified to include multiple pins (1000) which have a height of about 22 mm. The mold section which produces the lateral groove at the shoulder has a height of about 24 mm (610).

FIG. 7B shows a cross-section view of a pin having a core (1020) of a high thermal diffusivity material encased on its sides with a sheath (1010) of high yield strength, low thermal diffusivity material.

FIG. 8A shows the appearance of the tread of a truck tire when cured using the pins. The pin holes (50) are readily seen in the shoulder blocks (70). FIG. 8B shows a cross-section of the groove (60) and a pin hole (50) and demonstrates the relative depths of each.

### DETAILED DESCRIPTION OF PREFERRED EMBODIMENTS

In the process of curing a rubber article, particularly a non-uniform rubber article such as a tire or a tread for a tire, the challenge is to provide a curing method that provides a sufficient amount of heat energy to the cure-limiting part(s) of the rubber article to effect substantial cure of said part(s) without over curing other parts of the article, and to do so in a productive, time-efficient manner.

The method of the invention uses one or more pins made of high thermal diffusivity materials which protrude from the surface of a mold and intrude into cure-limiting portions of a rubber article to cause up to a 20% or more reduction in cure time in the mold.

The pins are made from high thermal diffusivity materials. The thermal diffusivity value of the material is defined as “thermal conductivity÷(density×specific heat)”. The thermal diffusivity value of the material of the pins is 4×10⁻⁵ m²/s (meters squared per second) or higher. Examples of materials having high thermal diffusivity values are silver, gold, copper, magnesium, aluminum, tungsten, molybdenum, beryllium and zinc. Alloys of these metals can also be used as long as the thermal diffusivity value of the alloy is 4×10⁻⁵ m²/s or higher.

Since the pins are used in molds for rubber articles and are subject to high pressure, heat and moisture, the pins must be selected to not react with the mold or the rubber article and its ingredients, especially during cure. This means that the material of the pin should (a) be compatible with the material of the mold and not cause oxidative or galvanic corrosion at the interface of the pin and the mold, and (b) not be reactive with the rubber and its ingredients, especially in a hot, moist environment as found in tire molds. Hence, in some situations, high thermal diffusivity materials such as substantially pure copper, magnesium and zinc may not be the best choices as materials for pins as these materials may be reactive with the uncured rubber article and its ingredients. However, even if the high thermal diffusivity material may be reactive with the rubber article and its ingredients, the reactive material can still be used as pins if the material is fully encased in a sheath of a non-reactive material, such as stainless steel. The non-reactive sheathing shields the reactive high-thermal diffusivity material core from the rubber article and its ingredients, yet still allows for a reduction in cure time.

Also, in some situations, high thermal diffusivity materials such as silver, gold, magnesium, molybdenum and beryllium may not be the best choices as materials for pins as pins made of these materials may not withstand the molding and demolding pressures due to low yield strength or brittleness of the high thermal diffusivity material. However, low yield strength or brittle high thermal diffusivity materials can be used as pins if the material is fully encased or encased on its sides in a sheath of high yield strength, mechanically resilient material such as steel. The sheathing supports the high thermal diffusivity material core and enables it to withstand the molding and de-molding forces.

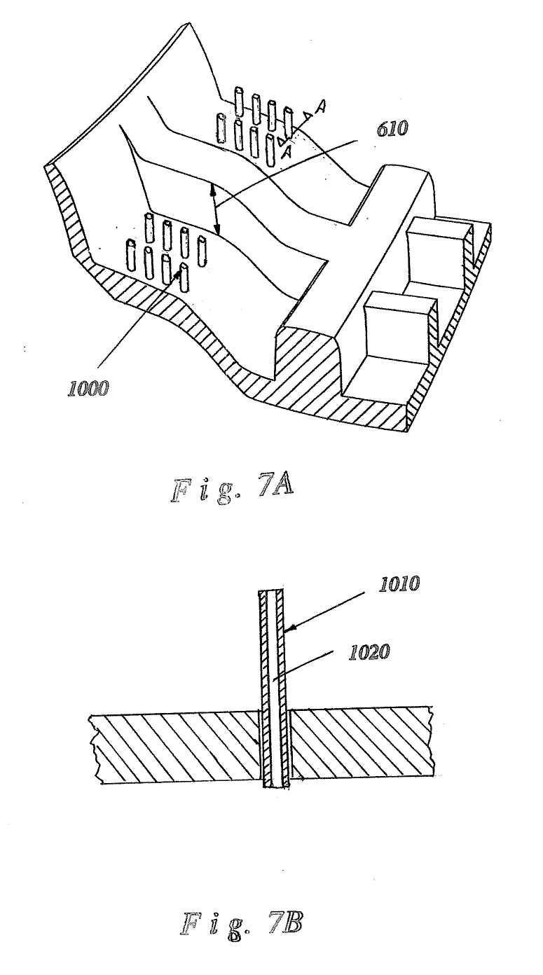

Further, regardless of the chemical and mechanical properties of the high thermal diffusivity material, encasing the high thermal diffusivity material in a sheathing of a material having low thermal diffusivity, i.e. less than 7×10⁻⁶ m²/s, can be advantageous. Examples of such materials include titanium, chrome-steel (Cr 20%), nickel-chrome alloys, and stainless steel. Non-metals, such as ceramics may also be suitable. In this approach it is advantageous to have the sheathing on only the sides of the pin and not the tip. The low thermal diffusivity sheathing acts as an insulator, reducing heat loss out the sides of the pin and improving heat transfer at the tip of the pin and to the cure-limiting parts of the article. FIG. 7B shows a pin with a core made out of a high thermal diffusivity material such as an aluminum ally and encased on its sides with high yield strength, low thermal diffusivity material such as stainless steel.

Pins having a core made of a high thermal diffusivity material encased by a sheath can be made by drilling a hole in the material used as the sheath and filling the hole with a high thermal diffusivity material. Also, the high thermal diffusivity core can be machined or otherwise formed and then pressed into tubes of the sheathing material to form the pins. Further, the pins can be made by coating the high thermal diffusivity material core with the sheath material by electroplating or other means.

Because of the concerns with reactive ingredients in the rubber article and mechanical forces in the mold, the more preferred high thermal diffusivity materials are tungsten and aluminum alloys. The more preferred sheathing material is stainless steel, due to its combination of high yield strength, non-reactivity, and low thermal diffusivity.

One or more of the high thermal diffusivity pins can be added to a mold in known ways such as by welding the pin(s) to the inside surface of the mold, by drilling holes through the mold and inserting the pin(s) through the mold so as to protrude outward from the surface of the mold, or the pins can be made as part of a new mold. The pin(s) can also be placed in a hole(s) made in the mold and maintained at a point where the pin tip is near the interior surface of the mold and, after the mold is closed, the pin(s) can be inserted into the rubber article by pressure or mechanical means such as a piston.

The pins can have any cross-sectional shape, such as round, square, triangular, hexagonal, octagonal, rectangular or elliptical. The pins can be thought of in terms of their nominal “x-y” geometry (i.e. the shape of the pin in the two dimensional “x and y” planes). If the horizontal “x and y” plane dimensions are substantially symmetrical (i.e. the “x and y” dimensions are approximately equal), the pin is basically round, square, hexagonal, octagonal, etc. If the pin has an asymmetrical shape (i.e. the “x and y” dimensions are substantially different), the pin is basically rectangular, elliptical, etc.

The cross-sectional area of the pin at the interior surface of the mold ranges from about 0.1% to about 1.0% of the surface area of the part acted upon, such as a tire block or rib. When the pin(s) is extracted from the article, a small aperture is formed on the surface of the article which is coincident with the size of the pin. If more than one pin is used, the combined cross-sectional area of all of the pins still ranges from about 0.1% to about 1.0% of the total surface area of the part acted upon, such as the tire block or rib.

To exemplify the above cross-sectional area limitations on the pin(s), truck tires having a block type tread pattern have a typical nominal surface area for the tread blocks ranging from about 900 mm² (i.e. about 30 mm by 30 mm) to about 5625 mm² (i.e. 75 mm by 75 mm). In this case, a single pin, which has a cross-sectional area of from about 0.1% to about 1.0% of the surface area of the tread block, can have “x and/or y” dimensions for the pin ranging from about 1 mm to about 7 mm. If multiple pins are used, the total combined cross-sectional areas of the pins still must be from about 0.1% to about 1.0% of the surface area of the tread block acted upon. Hence, if six pins are used for one block, the “x and/or y” dimensions for each pin would range from about 1 mm to about 3 mm.

The length of the pins in the vertical “z” dimension (i.e. the direction into the part of the rubber article being acted upon) is such that they extend into the article from about 25% to about 60% of the overall thickness of the part of the article acted upon.

For treads for tires, it is efficient to use one or more pins having a “z” dimension so as to protrude into the tread block by about 25% to about 50% of the total thickness of the tread. Hence, for a typical tread cap having a total thickness of 28 mm, the pins would have a “z” dimension (length) of from about 7 mm to about 14 mm.

For tires, it is efficient to use one or more pins having a “z” dimension that extends about 25% to about 110% of the thickness of the tread depth; and, more preferably, from about 50% to about 90% of the tread depth. For example, for a typical truck tire that has a nominal tread depth thickness of about 26 mm, the “z” dimension (length) of the pins ranges from about 5 mm to about 28 mm; and preferably from about 13 mm to about 24 mm.

The “z” dimension of the pin can protrude into the article perpendicular to the “x and y” dimension, or can be inclined. The pins can also be tapered at the top or bottom, or have a shape in the “z” dimension such as to show a “step-down” or a rounded “head” at the bottom like a mushroom shape.

It is sometimes preferable to use more than one pin, each of which has a smaller cross-sectional area at the interior surface of the mold (i.e. each ranging from about 0.1% to about 0.4% of the surface area of the part acted upon), than to use one pin, which has a larger cross-sectional area at the interior surface of the mold (i.e. ranging from about 0.5% to about 1.0% of the surface area of the part acted upon). This can be the case when there is a concern that using a pin of larger cross-sectional area would leave an aperture on the surface of the block large enough to collect debris, or when a curing a tire having a rib design as opposed to a block design. If more than one pin is used to act on a part, it is preferable to separate the pins from each other by a distance of about five times the average dimension of the pin. Hence, for a typical truck tire tread block, the distance between 3 mm pins would be about 15 mm. When a very large tire, such as an earthmover tire, is cured, it may be practical to use more than one pin of larger dimensions.

### Impact of Use of Pins on the Surface Area and Rigidity of the Blocks of a Tire.

As mentioned, the protrusion of the pins into the tire rib or tread block causes an aperture on the surface of the rib or block. To minimize the impact of the use of the pins on the function and performance of the tire, the reduction in the total surface area of the tire rib or tread block on which a pin, or multiple pins, acts ranges from about 0.1% to about 1%, and preferably from about 0.1% to about 0.5%, of the surface area of the tread block or rib acted upon.

Further, in order for the tire to function in its intended manner, the rigidity of the tire tread block or rib should not be substantially degraded by the apertures caused by the pin(s). For tire treads, this means that the tread block should maintain its rigidity after the use of the pins similar to that it would have if the pins were not used. The change in rigidity is related to the percent reduction in volume of the part acted upon which is caused by the use of the pin(s). For this invention, the use of one or more of the pins should cause a total reduction in the calculated rigidity of the tread block of 6% or less, and preferably of 2% or less.

The reduction in rigidity caused by the pin(s) is calculated by the formula “volume of the aperture(s) created by the pin(s)” divided by the “total volume of the part of the article which has been acted upon by the pin(s)”.

When the rigidity calculation is applied to a tire tread block, a multiplier was applied. The multiplier value was “1” for the first increment of 1 to 5 mm of depth; the multiplier was “2” for a second increment of over 5 to 10 mm of depth; the multiplier was “4” for a third increment of over 10 to 15 mm of depth; and the multiplier was “8” for any other increment of over 15 mm of depth or more.

If more than one increment is involved (which is the case for longer pins), the rigidity is calculated for each increment and the values obtained are added to give the total reduction in rigidity. For example, if a cylindrical pin is used which protrudes into a tread block by 14 mm, this leaves a cylindrical hole in the block which corresponds to the diameter and length of the pin. So, a rigidity calculation would be made for the volume of the aperture in first five mm increment and the multiplier is “1”. For the second five mm increment, another rigidity calculation is made for the volume of the aperture in the second increment and the multiplier is “2”. For the last four mm increment, another rigidity calculation is made for this increment and the multiplier is “4”. Then, the three calculations are added together to get the total reduction in rigidity caused by the pin. If more than one pin is used, a rigidity calculation is made for each pin. The calculations are then added together to get a combined value for the reduction in rigidity. The same process is used for all the shapes for the pins.

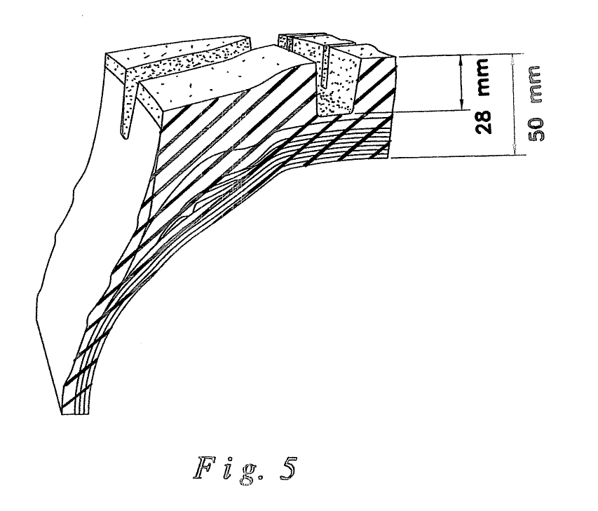

The pins used for a typical truck tire (see FIG. 5) can have varying lengths of from about 14 mm to about 29 mm (from 50% to about 110% of the tread depth), and varying diameters of from about 2 mm to about 4 mm.

The nominal surface area of a tread block in a typical truck tire is about 4200 mm². Hence, the calculated reduction in the surface area of the tread block caused by the pins ranges from about 0.1% to about 0.7%; and the calculated reduction in the rigidity of the tread block caused by the pins ranges from about 0.2% to about 6.0%. Calculations for various pin sizes are summarized below.

TABLE 1
Summary of Rigidity and Surface Area Calculations with Pins having
Different Dimensions.

| | | | Reduction in |
|---|---|---|---|
| | | Reduction in | Surface Area |
| Case | | Rigidity of the Block | Of the Block |
| A) | Base case | — | — |
| | No Pins | | |
| B) | One 2 mm diameter pin | | |
| 1) | 14 mm length | 0.3% | 0.1% |
| 2) | 18 mm length | 0.8% | 0.1% |
| 3) | 22 mm length | 1.0% | 0.1% |
| 4) | 26 mm length | 1.2% | 0.1% |
| 5) | 29 mm length | 1.2% | 0.1% |
| C) | One 4 mm diameter pin | 5.5% | 0.4% |
| | 26 mm length | | |
| D) | Eight 2 mm diameter | 2.1% | 0.7% |
| | pins | | |
| | 14 mm length | | |

The objective is to reduce the cure time in the press without significantly degrading the performance or function of the tire. Hence, the dimensions of the pins are selected to keep the reduction in the surface area below 1%, and the calculated reduction in rigidity at below 6%.

The high thermal diffusivity pins can be independently heated. This means that the pins can be heated on their own in addition to the heat transferred to the pins via conduction from the mold. Independent heating of the pin(s) can further reduce the cure time in the mold. A practical way to independently heat the pins involves the use of electrical resistance. The heating of the pins can continue during the cure of the article. The pins can be independently heated to a temperature of up to about 110% of the mold temperature chosen for the cure. For tires and tire treads, the pins would be normally be heated to from about 110 degrees Celsius to about 170 degrees Celsius, depending on the cure temperature for the tire or tread.

Hence, it is readily apparent that the method of this invention allows the practitioner flexibility in choosing the “x”, “y” and “z” dimensions of the high thermal diffusivity pins and the shape and number of the pins in order to optimize the desired cure results.

### Determining the “Cure-Limiting” Part(s) of a Rubber Article.

In a curing method using a conventional mold, an analysis can be made of the rate of heat transfer occurring in all parts of the rubber article. However, even knowing this, the total cure time period to cure the article is traditionally dictated by the time it takes to cure the “cure-limiting” part(s) of the rubber article. By “cure-limiting” part(s) is meant the part(s) of the article that take the longest time to cure. Hence, using traditional methods, the total cure time period in the mold is set to cure the cure-limiting parts, which results in longer cure times and inefficient use of the curing apparatus. Also, one must be careful to not over-cure other parts of the article which could result in loss of performance of the article at these over-cured parts

One method of determining the heat transfer which occurs during cure is to build a rubber article, place thermocouples within the article and record the thermal profiles during the curing process. This will identify the cooler parts; i.e. the “cure-limiting” parts, of the article. Knowing the thermal profile, one can use reaction kinetics to determine the state of cure throughout the article.

Another method is to identify the cure-limiting part(s) of a rubber article is to use Finite Element Analysis (FEA) which uses a computer model of the article that is subjected to external loads (i.e., thermal) and analyzed for results. Heat transfer analysis models the thermal dynamics of the articles. An example of using FEA analysis is found in Jain Tong et al, “Finite Element Analysis of Tire Curing Process”, Journal of Reinforced Plastics and Composites, Vol. 22, No. 11/2003, pages 983-1002.

### State of Cure

Alpha is a measure of the state of cure for a rubber composition. It is given by the following equation:

alpha=(time of curing)/t99

where t99 is the time for completion of 99% of the cure as measured by torque as shown by a rheometer curve. ASTM D2084 and ISO 3417 describe how to measure cure times (time t0 for the onset of cure, and time t99 for 99% completion of cure) for rubber compounds using an oscillating rheometer. These standards are incorporated by reference.

The method of the invention is particularly applicable to curing non-uniform rubber articles because these rubber articles typically have cure-limiting parts. By “non-uniform” is meant (a) thickness of the article, particularly varying geometrical thickness in the article, (b) varying materials composition in the article, (c) presence of laminate structure in the article, and/or (d) all of the above. A typical large tire, such as a truck tire, off-the-road tire, farm tire, airplane tire or an earthmover tire, is a good example of a non-uniform rubber article. However, any non-uniform rubber article, such as hoses, belts, vibration mounts, bumpers, etc., can be efficiently cured using the method of this invention.

A preferred embodiment of the present invention is a method of curing a tread for a tire. The method comprises (a) placing an uncured tread inside a mold; (b) inserting one or more high thermal diffusivity pins into one or more cure-limiting parts of the tread at a depth of between about 25% and about 60% of the overall thickness of the tread; (c) applying heat to the mold and the pin(s) until the tread reaches a defined state of cure; and (d) removing the one or more pins from the tread and removing the cured tread from the mold. The one or more pins have a total cross-sectional area at the interior surface of the mold of between about 0.1% and about 1.0% of the total surface area of the part of the tread into which the one or more pins were inserted.

Another preferred embodiment of the present invention is particularly applicable as a method of curing a tire. The method comprises (a) placing an uncured tire inside the mold; (b) inserting one or more high thermal diffusivity pins into one or more cure-limiting tread blocks or ribs of the tire at a depth of between about 50% and about 110% of the tread depth of the block or rib; (c) applying heat to the mold and the pin(s) until the tire reaches a defined state of cure; and (d) removing the one or more pins from the tire; and removing the cured tire from the mold. The one or more pins have a total cross-sectional area at the interior surface of the mold of between about 0.1% and about 1.0% of the total surface area of the one or more cure-limiting tread blocks or ribs of the tire into which the one or more pins were inserted.

Further reductions in time to cure in the mold can be achieved when the high thermal diffusivity pins of the mold are independently heated, i.e., heated by a source other than by conduction of heat via the mold.

### Example 1

### Testing Different Materials of Construction for the Pins

A mold apparatus was constructed to test various materials that can be used to make the pins. An aluminum mold was fabricated with a removable top. The cavity of the mold was 170 mm long by 190 mm wide by 40 mm in depth. A common curable rubber composition was placed in the mold. A steam platen press was used to heat the mold to 150° C. Pins made of different materials were attached to the inside surface of the top of the mold and were evaluated for their efficiency in reducing the cure time of the rubber block. The mold allowed for thermocouples to be placed inside the mold into the rubber block at select depths and at select distances from the pin(s). During cure, the mold was closed with 10 tons of force.

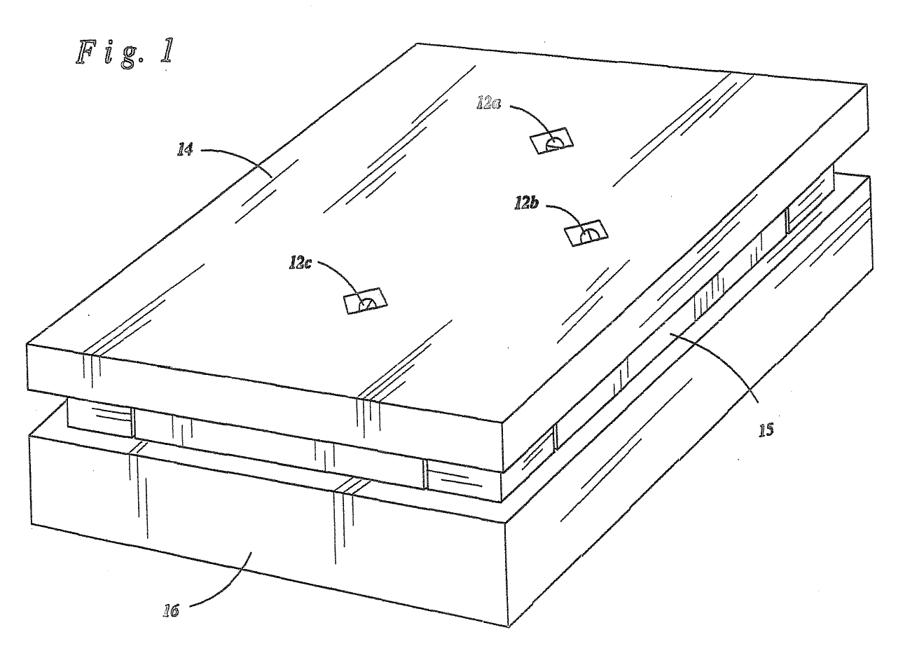

FIG. 1 shows the mold (14, 16), the rubber block (15) and the 3 pin (12a, 12b, 12c) locations on the top of the mold (14).

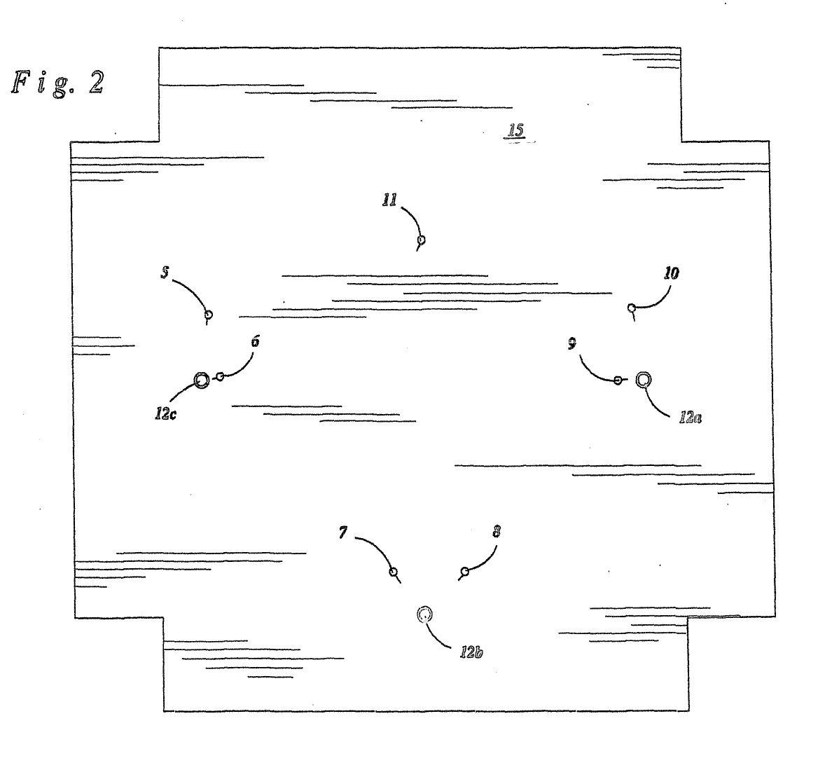

Each pin was circular, 3 mm in diameter and 20 mm in length. The pins intruded into the rubber block about half-way (50%) from the top surface. Thermocouples were also set at a depth of about 20 mm; i.e. the depth of the pins, at different distances from the pins. FIG. 2 shows the pin (12a, 12b, 12c) and the thermocouple locations (5-11) in the rubber block (15) in the mold.

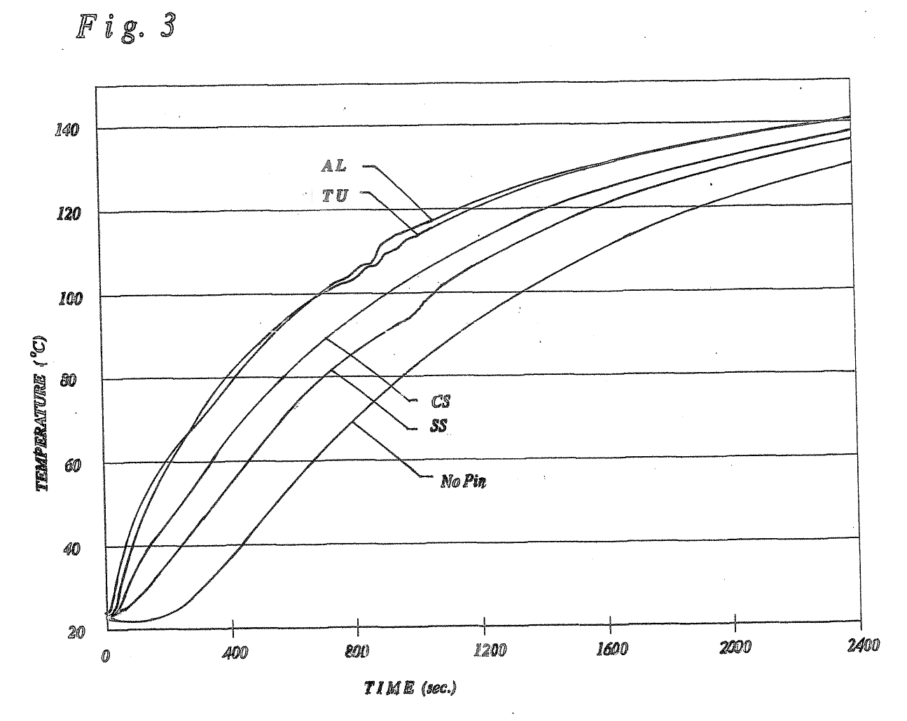

The mold and the rubber block were heated. The heat evolution (temperature as a function of time) was recorded for each thermocouple. The time for the rubber block to reach a cure state of alpha=0.9 was then calculated. FIG. 3 shows the cure curves generated with the use of the pins at thermocouple position 6. The following results were obtained.

TABLE 2
Summary of Cure Time Results Using Pins Made of
Different Materials (Measured using Thermocouple 6
at a Distance of 5.1 mm from the pin).

| | | | Time to | Percent |
|---|---|---|---|---|
| | | | Reach Alpha | Reduction |
| | | Thermal Diffusivity | Cure State | in Cure |
| Case | | (m²/s) | (minutes) | Time |
| A) | Base case - No | | 54.5 | |
| | Pins | | | |
| B) | Pin Material | | | |
| 1) | Aluminum 6061 in | 5.29 × 10⁻⁵ | 42 | 22.9 |
| | Stainless Steel 316 | | | |
| | sheath | | | |
| 2) | Tungsten | 6.92 × 10⁻⁵ | 43 | 21.1 |
| 3) | Carbon Steel | 1.48 × 10⁻⁵ | 47 | 13.7 |
| | (0.5%) | | | |
| 4) | Stainless Steel 316 | 4.04 × 10⁻⁶ | 49 | 10.1 |

The results show that the pins made of the high thermal diffusivity materials Aluminum (AL) and Tungsten (TU) yielded reductions in cure time of more than 20% at the thermocouple position. The carbon steel (CS) pin and the stainless steel (SS) pins are made of low thermal diffusivity materials. FIG. 3 shows the cure curves generated in this test at thermocouple position 6.

The aluminum alloy was sheathed on its sides with stainless steel. FIG. 7B shows this construction where the high thermal diffusivity core (1020) of aluminum 6061 is encased on its sides with a sheath (1010) of the high strength, low thermal diffusivity material stainless steel 316. The sheathing prevented damage to the aluminum pin in the press, and also acted to channel the heat to the tip of the pin.

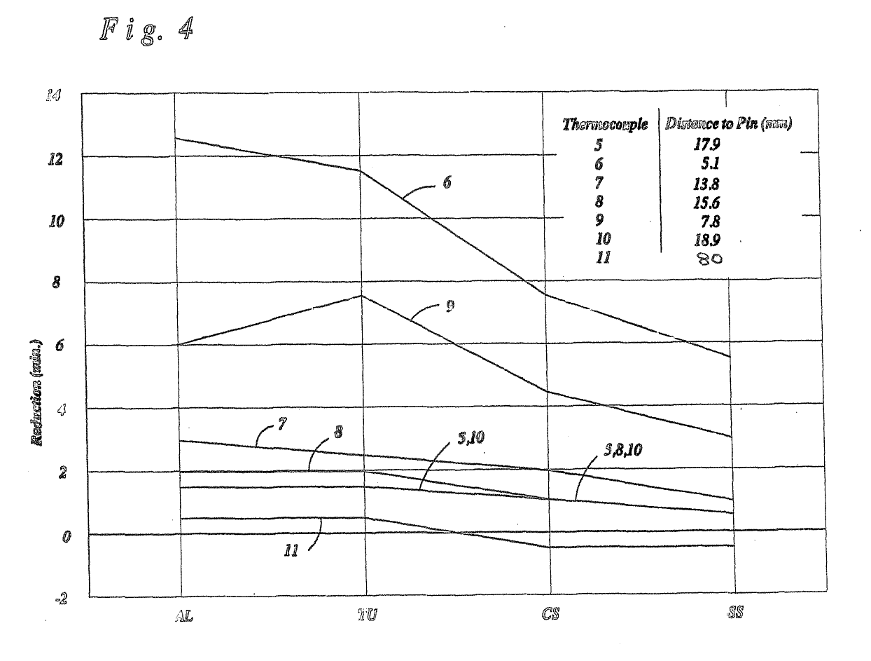

The same pattern in reducing cure times was observed at other thermocouple locations. FIG. 4 shows the time to reach a cure state of alpha=0.9 for the tungsten (TU) pin, the aluminum alloy (AL) pin, the carbon steel (CS) pin and the stainless steel (SS) pin at different thermocouple positions in the rubber block. The Figure shows that the pins made out of the high diffusivity materials tungsten (TU) and the aluminum alloy (AL) reduced the time to reach cure temperature at each thermocouple location.

### Independently Heating the Pins.

When a tire is removed from a mold, the heating of the mold is stopped and the mold remains open for a period of time. The mold cools down, and, if there are pins in the mold, the pins cool down. When another tire is placed in the mold and the mold closed, heating of the mold commences and the pins are heated via conduction of heat via the mold. However, to obtain shorter cure times, the pins can be independently heated using an independent heat source such as electrical resistance. The pins can be independently heated to a temperature of up to about 110% of the mold temperature chosen for the cure of the article. For a tire or tread, this temperature range is normally from about 110 degrees Celsius to about 170 degrees Celsius.

### Example 2

### Effect of the Pins on the Blocks of a Typical Truck Tire

The method of the invention can be applied to truck tires. A reduction in mold cure time can be achieved by placing pins into the shoulder tread blocks for a typical pneumatic truck tire (FIG. 5 shows the shoulder region of such a tire). The tread block depth is 28 mm and the overall thickness is 50 mm. The cure of this tire is limited by the cure-limiting part in the shoulder area. For example, the normal cure time for a typical truck tire using a conventional method is about 56 minutes, while the typical time for the bead to obtain a state of cure of alpha=0.9 is about 39 minutes, and the typical time for the sidewall to reach a state of cure of alpha=0.9 is about 22 minutes. Hence, the bead part of the tire has about 17 minutes of additional heating and the sidewall part of the tire has about 34 minutes of additional heating.

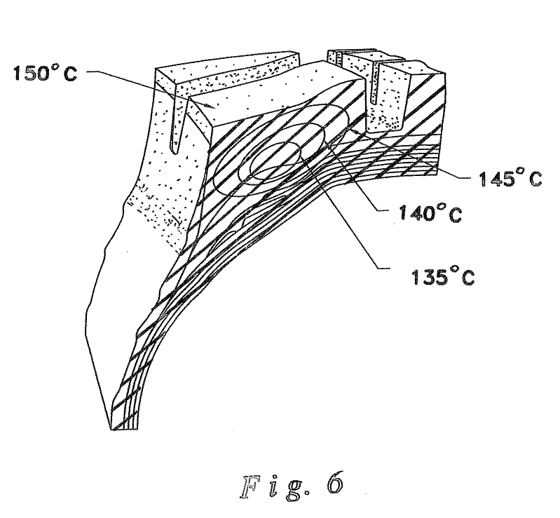

FIG. 6 shows the heat profile which is developed in the shoulder region of the tire depicted in FIG. 5 when the tire is cured in a conventional manner. It is seen that, at the end of the cure, the temperature within the center of the tread shoulder block is about 15° C. cooler than the temperature at the surface of the tread block. Hence, the interior of the shoulder tread block is the cure-limiting part of this tire.

FIG. 7A shows an example of a mold modified with pins (1000) to introduce heat into the cure-limiting shoulder tread blocks of the tire. FIG. 7B shows an example of a pin made of a high thermal diffusivity core (1020) encased with a sheath (1010) of high yield strength, low diffusivity material.

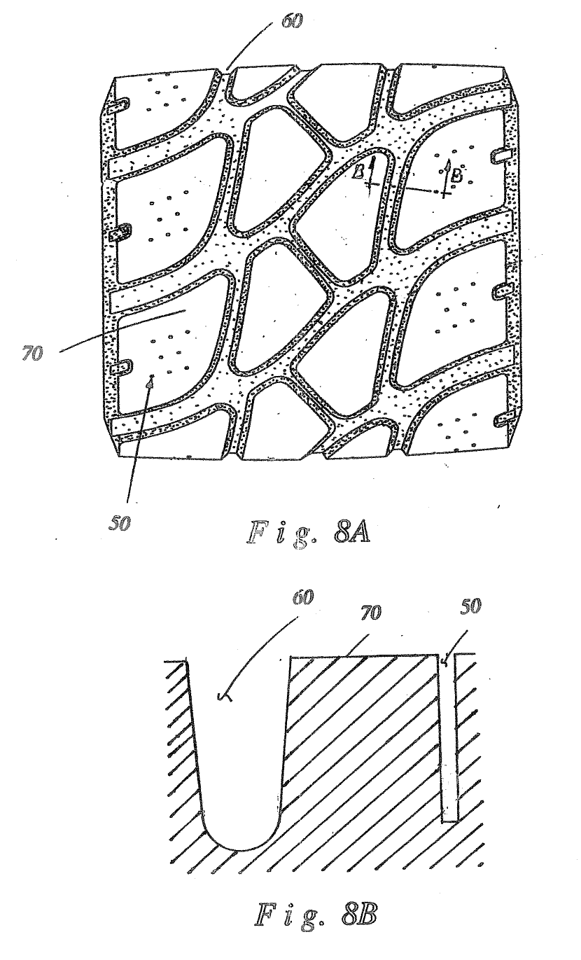

FIG. 8A shows the appearance of a tread of a truck tire where pins were used to reduce the cure time in the shoulder blocks. The pin holes (50) are readily seen in the shoulder tread blocks (70). FIG. 8B shows the relative depths of the tire groove (60) and the pin holes (50). In this case the pins intrude into the tread block to about 90% of the groove depth.

The method of the invention was described with respect to its use in curing tires and tire treads. However, it is understood that the method can be used with other non-uniform rubber articles.

1. A method of curing a tire comprising the steps of:
(a) placing the uncured tire inside a mold;
(b) inserting one or more high diffusivity pins into the tire at one or more cure-limiting tread blocks or ribs of the tire to a depth of between about 50% and about 110% of the tread depth of the block or rib;
(c) applying heat to the mold and the one or more pins until the tire reaches a defined state of cure; and
(d) removing the one or more pins from the tire, and removing the cured tire from the mold;

2. (canceled)

3. The method of claim 1, wherein the one or more pins have a total cross-sectional area at the interior surface of the mold of between about 0.1% and about 1.0% of the total surface area of the one or more cure-limiting tread blocks or ribs of the tire into which the one or more pins were inserted.

4. (canceled)

5. The method of claim 1, wherein the one or more pins are cylindrical pins which have a diameter of from about 1 millimeter to about 7 millimeters and a length such as to protrude into the cure-limiting parts of the tread blocks or ribs from about 50% to about 90% of the tread depth.

6. The method of claim 1, wherein the one or more pins are independently heated up to about 110% of the mold temperature.

7. (canceled)

8. The method of claim 1, wherein the one or more pins comprise a high thermal diffusivity material encased at least on its sides by a sheath of high yield strength, non-reactive, low thermal diffusivity material.

9. The method of claim 8, wherein the high yield strength, non-reactive, low thermal diffusivity material is stainless steel.

10. A method of curing a non-uniform rubber article comprising the steps of:
(a) placing the uncured article inside a mold;
(b) inserting one or more high thermal diffusivity pins into the cure-limiting parts of the article at a depth of between about 25% and about 60% of the overall thickness of the article;
(c) applying heat to the mold and the pins until the article reaches a defined state of cure; and
(d) removing the one or more pins from the article, and removing the cured article from the mold.

11. The method of claim 10, wherein the article is a tread for a tire.

12. The method of claim 10, wherein the one or more pins have a total cross-sectional area at the interior surface of the mold of between about 0.1% and about 1.0% of the total surface area of the one or more cure-limiting tread blocks or ribs into which the one or more pins were inserted.

13. (canceled)

14. The method of claim 10, wherein the one or more pins are cylindrical pins that have a diameter of from about 1 millimeter to about 7 millimeters and a length so as to intrude into the cure-limiting part of the article from about 25% to about 50% of the thickness of said part of the article.

15. The method of claim 10, wherein the one or more pins are independently heated by a source other than the mold to a temperature up to about 110% of the cure temperature.

16. (canceled)

17. The method of claim 10, wherein the one or more pins comprise a high thermal diffusivity material encased at least on its sides by a sheath of high yield strength, low thermal diffusivity material.

18. (canceled)

19. A mold for curing a tire having at least one pin located at a position on the inner surface of the mold which intrudes into the tire at a cure-limiting part of the tire during the cure of the tire, wherein the pin is made of a high thermal diffusivity material.

20. The method of claim 3, wherein the one or more pins have a total cross-sectional area at the interior surface of the mold of between about 0.1% and about 0.5%.

21. The method of claim 10, wherein the one or more pins have a total cross-sectional area at the interior surface of the mold of between about 0.1% and about 0.5%.
